(19) United States
(12) Patent Application Publication
(10) Pub. No.: US 2009/0134858 A1
(43) Pub. Date: May 28, 2009

(54) VOLTAGE REGULATING APPARATUS AND METHOD AND VOLTAGE REGULATOR THEREOF

(76) Inventors: Yi-Huei CHEN, Hsinchu City (TW); Chao-Cheng LEE, Hsinchu City (TW)

Correspondence Address: BIRCH STEWART KOLASCH & BIRCH, PO BOX 747, FALLS CHURCH, VA, 22040-0747, US

(21) Appl. No.: 12/277,048

(22) Filed: Nov. 24, 2008

(30) Foreign Application Priority Data
Nov. 28, 2007 (TW) 96145263

(51) Int. Cl. G05F 1/00

(52) U.S. Cl. 323/282

(57) ABSTRACT

A voltage regulating apparatus and method and voltage regulator thereof are presented. The apparatus includes a first regulator and a second regulator. The first regulator is used for receiving an input voltage and outputting a first voltage according to the input voltage. When the input voltage reaches a steady voltage value, the second regulator is turned on so as to receive the first voltage provided by the first regulator and output a second voltage according to the first voltage or the input voltage.

### CROSS-REFERENCES TO RELATED APPLICATIONS

This non-provisional application claims priority under 35 U.S.C. §119(a) on Patent Application No(s). 96145263 filed in Taiwan, R.O.C. on 2007111/28, the entire contents of which are hereby incorporated by reference.

### BACKGROUND OF THE INVENTION

1. Field of Invention

The present invention relates to a voltage regulating apparatus and method, and more particularly to a voltage regulating apparatus and method and voltage regulator thereof.

2. Related Art

Please refer to FIG. 1A, in which the architecture of a switch regulator in the prior art is shown. The conventional switch regulator has a high voltage conversion efficiency, and is thus commonly used to convert a large voltage difference and a large load current. However, as a large inductor A10 is required at the output terminal of the regulator's architecture, an excessively high current or power surge of the output voltage may occur when the device is on. Therefore, a soft-start apparatus A20 and an over current protection apparatus A30 are needed. However, use of this apparatus results in the rising speed of the output voltage being slow, and the time required to stabilize the current is too long.

What's worse, during the early stages of the switch regulator being turned on, the duty cycle controlling the activation of an N/P MOS A40 (i.e., NMOS/PMOS) is quite low due to the extremely low output voltage, such that the N/P MOS A40 may be simultaneously turned on due to a false control signal, thus generating a short-circuit current. In the conventional techniques, a non-overlap clock generator A50 is commonly adopted to control signals, so as to ensure sufficient dead time.

Moreover, in order to avoid a short-circuit current caused by the simultaneous activation of the N/P MOS A40 above, the duty cycle or the dead time of the control signal needs to be additionally monitored and adjusted so as to prevent the occurrence of a large current. However, an additional circuit must be employed at the cost of extra current using this method. Due to the strict requirements of chips (ICs) of the current specification when in sleep mode (power saving mode) and the complex design and high current demands of the switch regulator when inactive, it is difficult to achieve the current specification required, when the regulator is in sleep mode. Furthermore, the application will become more complicated if an additional auxiliary circuit is also needed.

### SUMMARY OF THE INVENTION

A first objective of the present invention is to provide a voltage regulating apparatus and method thereof capable of ensuring sufficient dead time to prevent from the short-circuit current.

A second objective of the present invention is to provide a voltage regulating apparatus and method thereof capable of enhancing the rising speed of the output voltage to prevent from the time required to stabilize the current being too long.

A third objective of the present invention is to provide a voltage regulating apparatus and method thereof capable of having a high voltage conversion efficiency.

A fourth objective of the present invention is to provide a voltage regulating apparatus and method thereof capable of having a large load current.

A fifth objective of the present invention is to provide a voltage regulating apparatus and method thereof capable of reducing the power consumption.

To achieve the foregoing objectives, according to an aspect of the present invention. Accordingly, the present invention is directed to a voltage regulating apparatus and method thereof. The apparatus, method or voltage regulator is capable of shortening the time required to stabilize the output voltage and effectively solving the above problems.

A voltage-regulating method is proposed. The method includes the steps of: receiving an input voltage by a first regulator, and outputting a first voltage according to the input voltage; turning on a second regulator when the input voltage reaches a predetermined voltage value; and outputting a second voltage by the second regulator according to at least one of the input voltage and the first voltage. Wherein, a value of the first voltage is smaller than that of the second voltage.

A voltage-regulating apparatus having an output terminal is also proposed. The apparatus includes a first regulator and a second regulator. The first regulator is coupled to the output terminal to receive an input voltage, and outputs a first voltage. The second regulator is coupled to the output terminal to output a second voltage when the input voltage reaches a predetermined value. Wherein the input voltage is increased from an initial voltage to a steady voltage, and the predetermined voltage value is between the initial voltage and the steady voltage, and the first voltage is output by the first regulator circuit to serve as the output voltage before the second voltage output by the second regulator circuit as the output voltage.

Embodiments of the present invention and efficacies thereof are described below with the accompanying drawings.

### BRIEF DESCRIPTION OF THE DRAWINGS

The present invention will become more fully understood from the detailed description given below, which is provided for illustration only (and thus not limiting the present invention), wherein:

FIG. 1A shows an architecture of a switch regulator in the prior art;

FIG. 1B shows an architecture of a linear regulator in the prior art;

FIG. 2 is a schematic view of a regulator apparatus;

FIG. 3 is a graph illustrating the relationship between voltage and time of a regulator apparatus in operation; and

FIG. 4 is a flow chart of a voltage-regulating method.

### DETAILED DESCRIPTION OF THE INVENTION

Types of regulator apparatuses are described first before the explanation of the present invention. A regulator apparatus functions to convert an input voltage, and to output a steady operating voltage which is used by other circuits. Regulator apparatuses can be classified into boost regulators and buck regulators depending on the comparison between the input voltage and the output voltage.

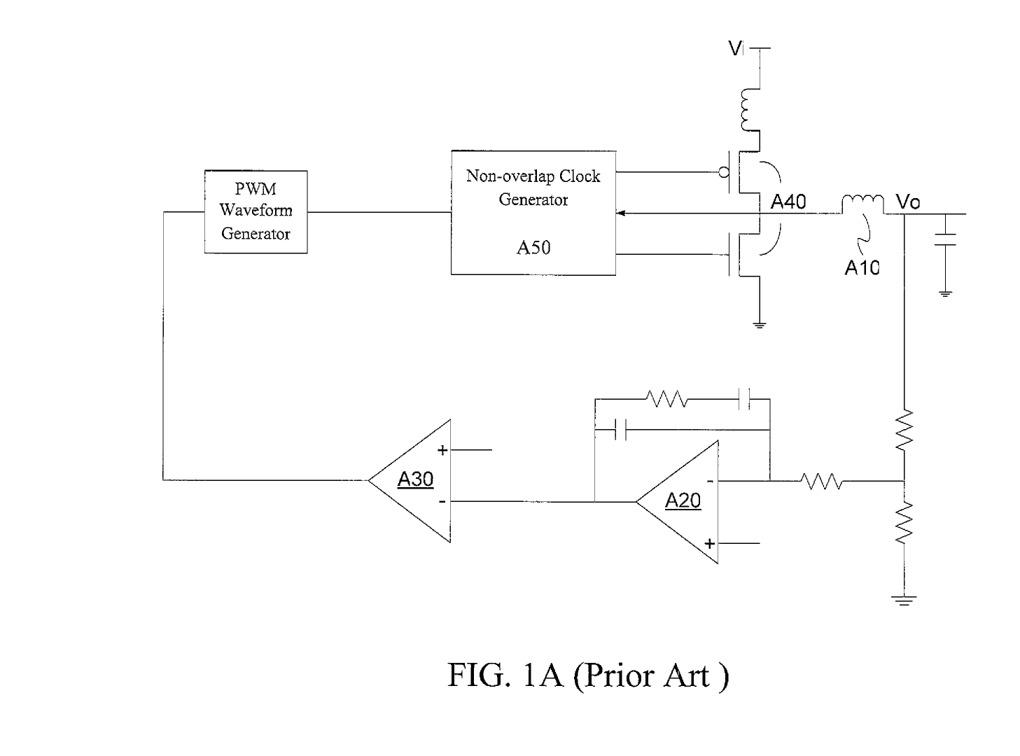

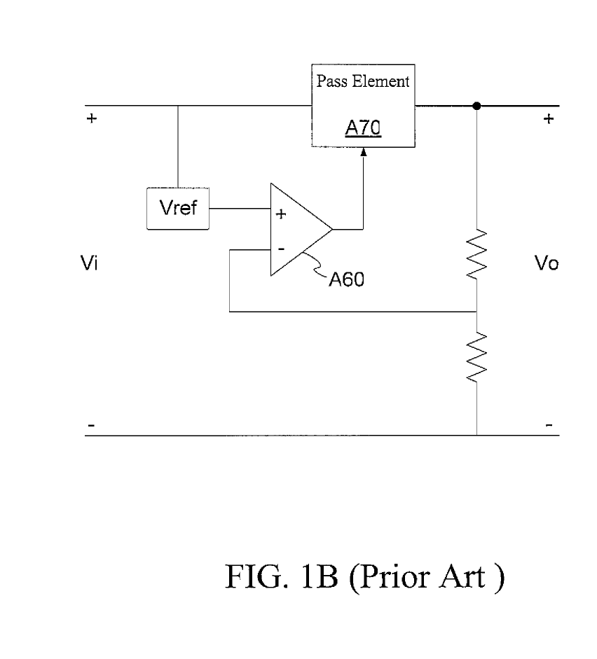

Moreover, regulators may also be divided into switch regulators and linear regulators depending on the architecture and applications thereof. FIG. 1A shows the architecture of a switch regulator, and FIG. 1B shows the architecture of a linear regulator. Referring to FIG. 1B, the linear regulator includes a comparator A60 and a pass element A70. The pass element A70 may be constituted of a variety of different elements so as to form various types of linear regulators.

Being simpler in structure than a switch regulator, a linear regulator is superior to the switch regulator in circuit design and current consumption. However, one of the disadvantages of the linear regulator lies in its low energy conversion efficiency. In contrast, the switch regulator achieves a conversion efficiency higher than that of the linear regulator through low-resistance switches and magnetic power storage units, thus reducing power loss in the conversion process. Since the principles, efficacies, and specified implementations of the two regulators are apparent to those skilled in the art, the details will not be described herein again. In addition, as demonstrated previously, the linear regulator and the switch regulator have their own respective advantages and disadvantages.

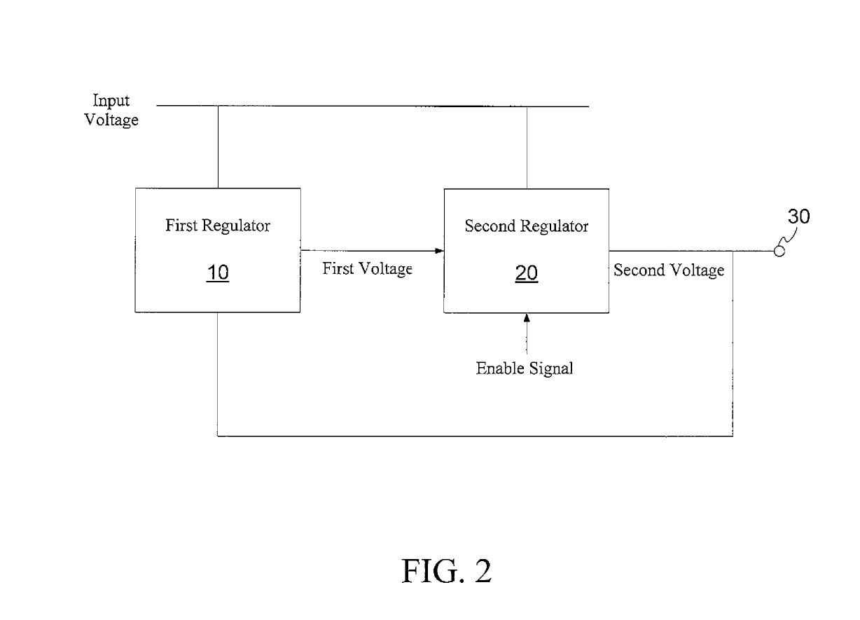

FIG. 2 is a schematic view of a regulator apparatus of the present invention. The regulator apparatus can be positioned inside or outside a chip (IC). The regulator apparatus includes a first regulator 10 and a second regulator 20.

First, when an input voltage is provided for the regulator apparatus of the present invention, a period of time for voltage rise is needed, as the input voltage must be increased from zero volt to a steady voltage value in the early stage of the input voltage's initialization. Conventionally, the errors are frequently happened in a switch regulator during this period in which the input voltage rises before reaching a steady value. Therefore, it is suggested in the present invention that the switch regulator is not turned on in the early stage of the input voltage's initialization. That is, the second regulator 20 of the present invention is disabled first. Therefore, the first regulator 10 is first turned on in the early stage of the input voltage's initialization. The first regulator 10 is coupled to an output terminal 30. On receiving the input voltage, the first regulator 10 outputs a first voltage (also referred to as a reference voltage). In addition, the first regulator 10 is a linear regulator.

The first voltage is smaller than a second voltage (i.e., the so-called operating voltage). A value of the first voltage is close to that of the second voltage finally output to the chip, and will be described in detail below by an example. When the input voltage rises to a predetermined voltage value (i.e., the input voltage is a steady voltage value), the second regulator 20 is turned on. The second regulator 20 is also coupled to the output terminal 30. Therefore, the second regulator 20 is parallel with the first regulator 10 and outputs together. The second regulator 20 receives the first voltage provided by the first regulator 10, and then outputs a steady second voltage according to the first voltage or the input voltage. A value of the second voltage is smaller than the predetermined voltage value.

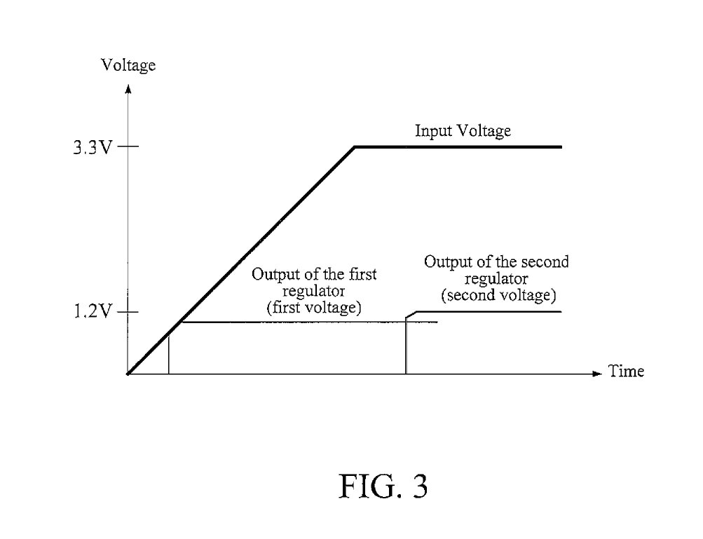

FIG. 3 is a graph illustrating the relationship between voltage and time of a regulator apparatus in operation. Referring to FIG. 3, the change of the relationship of the voltages with time when the regulator apparatus of the present invention is in operation, is illustrated by an example. Assuming that the input voltage is 3.3 V, the first voltage output by the first regulator 10 is set to 1.0 V, and the second voltage output by the second regulator 20 is set to 1.2 V. As seen in the figure, during the rising period of the input voltage's initialization, the second regulator 20 is not in action, and the first regulator 10 is first turned on instead. The first regulator 10 receives the input voltage and then outputs a first voltage of 1.0 V. When the input voltage continuously rises to a steady voltage value of 3.3 V, the second regulator 20 is turned on. However, as the second regulator 20 is additionally turned on, the overall power consumption of the apparatus is increased accordingly. Therefore, in another embodiment of the present invention, in order to reduce the power consumption, a determination condition is added, i.e., it is determined whether to enter a normal mode. That is, although the input voltage reaches the steady voltage value of 3.3 V, the second regulator 20 is not turned on for the moment if it is determined that it is unnecessary to enter the normal mode, thus saving power. When the input voltage reaches the steady voltage value and it is determined to enter the normal mode, an enable signal is output by a control circuit (not shown) to turn on the second regulator 20.

The first voltage output by the first regulator 10 or the input voltage that reaches the steady voltage value serves as an initial voltage of the second regulator 20 when turned on. That is, the second regulator 20 already has a voltage value close to the second voltage value before being turned on. If the initial voltage of the second regulator 20 when turned on does not reach the second voltage value, an extra current may still be generated. A soft-start mechanism is required for the purpose of complete suppression. However, since the initial voltage value is close to the second voltage value of the second regulator 20, the steady state can be quickly achieved even if the soft-start is adopted. Therefore, the soft-start is unnecessary and the soft-start mechanism can be omitted, so that the power consumption is reduced.

In addition, the first regulator 10 has a first property and the second regulator 20 has a second property, where the first property is different from the second property. The first property of the first regulator 10 has a first quiescent current, and the second property of the second regulator 20 has a second quiescent current. The first regulator 10 may be a linear regulator, and the second regulator 20 may be a switch regulator. As the linear regulator does not need to bear a large current output, the circuit is simpler and the required quiescent current is smaller. Therefore, the above first quiescent current is smaller than the second quiescent current. In this manner, when the circuit enters sleep mode (i.e., the second regulator 20 is turned off), unnecessary current waste can be avoided. Moreover, the circuit consumes less power when the output of the linear regulator is smaller than the second voltage. Therefore, the required current specification can be easily achieved, so as to meet the current specification demanded by the sleep mode.

Similarly, the first property of the first regulator 10 has a first drive current and the second property of the second regulator 20 has a second drive current, where the second drive current is larger than the first drive current. When entering normal mode, the whole regulator apparatus is dominated by the second regulator 20 so as to provide the drive current. Therefore, the first regulator 10 can be turned off when the chip enters normal mode.

The regulator apparatus of the present invention does not particularly need to switch the first regulator 10 and the second regulator 20. Since the first voltage value output by the first regulator 10 is smaller than the second voltage value, when the second regulator 20 is turned on the output of the whole regulator apparatus is automatically controlled by the second regulator 20 once the second voltage value output by the second regulator 20 exceeds the first voltage value output by the first regulator 10. Therefore, no switching action is required. If it is intended to control the operation of the regulator apparatus more precisely, the switching action can certainly be performed through switches or in a disabling/enabling manner.

Further, as only the first regulator 10 is used in the early stage of the power-on of the input voltage, no extra large transient current is generated. Moreover, as the second regulator 20 already has a first voltage value above zero and is close to the second voltage value when turned on, the duty cycle of the pulse width modulation (PWM) is not too small. In this manner, no short-circuit current is generated due to the simultaneous activation of the NIP MOS. If the output second voltage does not start from zero, the large transient current will be greatly reduced, and the soft-start mechanism can even be omitted or the time for soft-start can be shortened. In this way, the time required for outputting a steady second voltage is reduced.

The objectives of the present invention can be achieved as long as the two regulators have different electrical properties (for example, having different quiescent currents and/or different drive currents). For example, besides being a switch regulator, the above second regulator 20 may also be a linear regulator. In other words, the regulator apparatus of the present invention may be combined by a linear regulator and a switch regulator, or by two linear regulators.

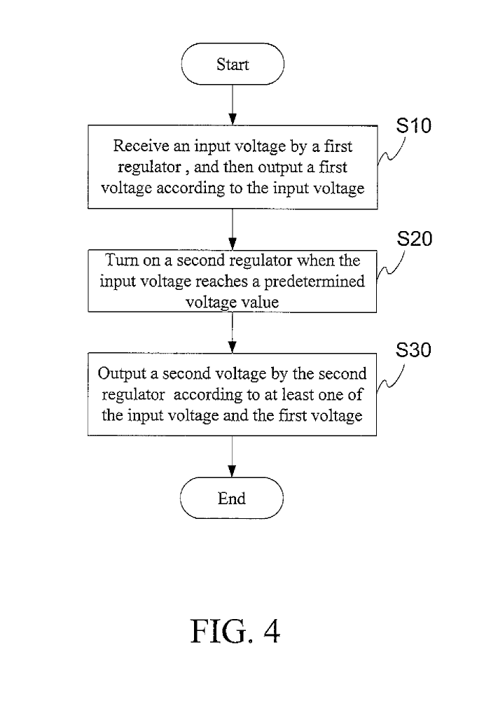

FIG. 4 is a flow chart of a voltage-regulating method of the present invention. The method includes the following steps.

In Step S10, a first regulator receives an input voltage. The first regulator is turned on to receive the input voltage in the early stage of the power-on of the input voltage, i.e., before the input voltage reaches a steady voltage value. On receiving the input voltage, the first regulator outputs a first voltage according to the input voltage. The first voltage value is smaller than the second voltage value.

In Step S20, a second regulator connected in parallel with the first regulator is turned on when the input voltage reaches a steady voltage value (also referred to as a predetermined voltage value). Moreover, in order to save power, the time for turning on the second regulator can be delayed. Therefore, besides determining whether the input voltage reaches the steady voltage value, it is also determined whether a chip enters normal mode. If the above two conditions are satisfied, the second regulator is turned on. The activation mode may send an enable signal by a control circuit to the second regulator.

In Step S30, after being turned on the second regulator receives the first voltage or the input voltage transmitted by the first regulator (as the input voltage has reached the steady voltage value). A large voltage value (i.e., the first voltage value or the steady voltage value) is received by the second regulator when turned on, so many problems in the prior art can be solved, such as low rising speed and excessively long stabilizing time of the output second voltage caused by the soft-start apparatus, and short-circuit currents generated due to the extremely short duty cycle.

Finally, the second regulator outputs a second voltage according to the first voltage or the input voltage. The second regulator is a switch regulator or a linear regulator. A voltage value of the second voltage is smaller than the predetermined voltage value.

In one aspect, a first property of the first regulator has a first quiescent current, a second property of the second regulator has a second quiescent current, and the first quiescent current is smaller than the second quiescent current. Therefore, when the chip enters sleep mode, the second regulator is turned off for reducing the power consumption.

In another aspect, the first property of the first regulator has a first drive current, the second property of the second regulator has a second drive current, and the second drive current is larger than the first drive current. Therefore, when entering normal mode, the chip can simply be driven by the drive current provided by the second regulator as the drive current of the second regulator is large, and thus the first regulator can be turned off.

Though the content of the present invention has been disclosed above by the preferred embodiments, they are not intended to limit the present invention. Anyone skilled in the art can make some modifications and variations without departing from the spirit and scope of the present invention. Therefore, the protecting range of the present invention falls within the appended claims.

What is claimed is:

1. A voltage-regulating method, comprising:
receiving an input voltage by a first regulator, and outputting a first voltage according to the input voltage;
turning on a second regulator when the input voltage reaches a predetermined voltage value; and
outputting a second voltage by the second regulator according to at least one of the input voltage and the first voltage,
wherein a value of the first voltage is smaller than that of the second voltage.

2. The method according to claim 1, wherein the first regulator comprises a first quiescent current, the second regulator comprises a second quiescent current, and the first quiescent current is smaller than the second quiescent current.

3. The method according to claim 1, wherein the first regulator comprises a first drive current, the second regulator comprises a second drive current, and the first drive current is smaller than the second drive current.

4. The method according to claim 1, wherein the first regulator is a linear regulator, and the second regulator is a switch regulator or a linear regulator.

5. The method according to claim 1, wherein the predetermined voltage value is a steady voltage value.

6. The method according to claim 1, wherein the value of the second voltage is smaller than the predetermined voltage value.

7. The method according to claim 1, wherein the step of turning on the second regulator further comprises:
turning on the second regulator in normal mode.

8. The method according to claim 1, further comprising:
turning off the second regulator in sleep mode.

9. The method according to claim 1, further comprising:
turning off the first regulator in normal mode.

10. A voltage-regulating apparatus, having an output terminal, comprising:
a first regulator, coupled to the output terminal, for receiving an input voltage and outputting a first voltage; and
a second regulator, coupled to the output terminal, for outputting a second voltage when the input voltage reaches a predetermined voltage value;
wherein the input voltage is increased from an initial voltage to a steady voltage, and the predetermined voltage value is between the initial voltage and the steady voltage, and the first voltage is output by the first regulator circuit to serve as the output voltage before the second voltage output by the second regulator circuit as the output voltage.

11. The apparatus according to claim 10, wherein the first regulator has a first property, the second regulator has a second property, and the first property is different from the second property.

12. The apparatus according to claim 10, wherein the first regulator comprises a first quiescent current, the second regulator comprises a second quiescent current, and the first quiescent current is smaller than the second quiescent current.

13. The apparatus according to claim 10, wherein the first regulator comprises a first drive current, the second regulator comprises a second drive current, and the second drive current is larger than the first drive current.

14. The apparatus according to claim 10, wherein the second regulator outputs the second voltage according to one of the first voltage and the input voltage.

15. The apparatus according to claim 10, wherein the first regulator is a linear regulator, and the second regulator is a switch regulator or a linear regulator.

16. The apparatus according to claim 10, wherein the predetermined voltage value is a steady voltage value.

17. The apparatus according to claim 10, wherein a value of the first voltage is smaller than that of the second voltage.

18. The apparatus according to claim 10, wherein the value of the second voltage is smaller than the predetermined voltage value.

19. The apparatus according to claim 10, wherein at least the second regulator is turned on or the first regulator is turned off in a normal mode.

20. The apparatus according to claim 10, wherein the second regulator is turned off in a sleep mode.
